(19) United States
(12) Patent Application Publication
(10) Pub. No.: US 2012/0172090 A1
(43) Pub. Date: Jul. 5, 2012

(54) Protective Case with Speaker and Microphone

(76) Inventor: Adrienne H. Capps, Fuquay-Varina, NC (US)

(21) Appl. No.: 12/980,403

(22) Filed: Dec. 29, 2010

(51) Int. Cl. H04W 88/02

(52) U.S. Cl. 455/566

(57) ABSTRACT

A protective case for an portable electronic communications device includes an embedded speaker, an embedded microphone, and a headphone type plug on a cord. The plug plugs into a corresponding port on the electronic device to power the microphone and speaker and to connect them to the device's electronics. The speaker is mounted in spaced relation to the microphone so that the display of the electronic device is disposed therebetween. The result is that the speaker is at the “top” of the device, and the microphone is at the bottom of the device, with the display spacing the two apart so that they are disposed like in a conventional phone headset. The case is particularly useful for devices with Wi-Fi capability but no cellular service.

### BACKGROUND

Numerous portable wireless communications devices exist on the market today. For example, portable cellular telephones have become almost ubiquitous. Many of the wireless communications devices rely primarily on the cellular telephone infrastructure in order to communicate with other wireless communications devices. Such is the case with basic cellular telephones. More sophisticated devices, known as smartphones, are frequently designed to also work with other wireless networks, such as “Wi-Fi” networks. However, smartphones also require a subscription to a cellular service provider, and the costs of such subscriptions have proven quite burdensome for many situations, particularly families with several children having cellular telephones.

Other portable electronic devices have been developed, such as the portable MP3 players. These devices have also evolved, and more sophisticated ones currently also allow video viewing and internet access through Wi-Fi connections, and therefore may be considered as wireless communications devices. Such devices are typically configured with an earphone jack for connecting with a corresponding plug of a small earpiece speaker (“earphone”).

Separately, a number of web-based “telephone” programs have been developed, such as the SKYPE brand program. These programs allow for a web-enabled device to place a telephone call without being initially connected to the telephone (including cellular telephone) network. That is, these programs allow for the uplink for the device to be carried on a non-cellular network, e.g., the internet via a Wi-Fi connection. For example, a user having a desktop computer connected only to the internet to place a “call” to a phone number and thereafter have a conversation, and sometimes a video conference, with the party on the other end, even though the desktop computer is connected to the telecommunications network only through the internet connection. However, having to use a non-portable desktop computer clearly limits the utility of such an approach, as portability is highly desirable. Using a laptop computer is a slightly better alternative, but still highly cumbersome.

What is desired is the ability to have a phone-like experience, with call-out and optionally call-in ability, using a wireless communications system other than a cellular system, so as to be able to avoid the cellular phone subscription charges. One possible avenue is to use a non-cellular Wi-Fi enabled portable wireless communications device, such as the IPOD TOUCH brand product from Apple, Inc. However, such devices do not have microphones, and more importantly do not have a microphone and speaker separated from each other so that the microphone may be placed proximate a user's mouth and the speaker proximate the user's ear. As such, it is not possible, using the prior art, to use such devices and have a communications experience like using a phone conventional handset with its concomitant privacy. Accordingly, there remains a need for alternative approaches to wireless communications devices.

### SUMMARY

The present invention provides a protective case for a wireless communications device having a display on a front thereof and an earphone jack. The protective case comprises a shell which comprises: a back; sidewalls extending generally perpendicular to the back; a cavity defined by the back and sidewalls; the cavity sized and configured to receive the wireless communications device therein. A rim extends from the sidewalls generally opposite the back; the rim defines a display opening sized and configured to expose the wireless communications device display when the wireless communications device is disposed in the cavity. The case further includes a speaker embedded in the shell and a microphone embedded in the shell, with the speaker and microphone disposed on opposite sides of the display opening. The case further includes a connection cable affixed toward one end to the shell and comprising a cord and an electrical plug with the cord operatively connecting the plug to both the microphone and the speaker. The connection cable may be affixed to the shell proximate the microphone. The shell may advantageously be flexible. The case may further include a clip affixed to an exterior of the shell and adapted to secure at least one of the plug and the cord.

In various embodiments, the present invention has one or more of the above attributes, alone or in any combination.

### BRIEF DESCRIPTION OF THE DRAWINGS

FIG. 1 shows a case according to one embodiment of the present invention installed on a wireless communications device in an unplugged configuration.

FIG. 2 shows partially exploded view of the combinational device shown in FIG. 1.

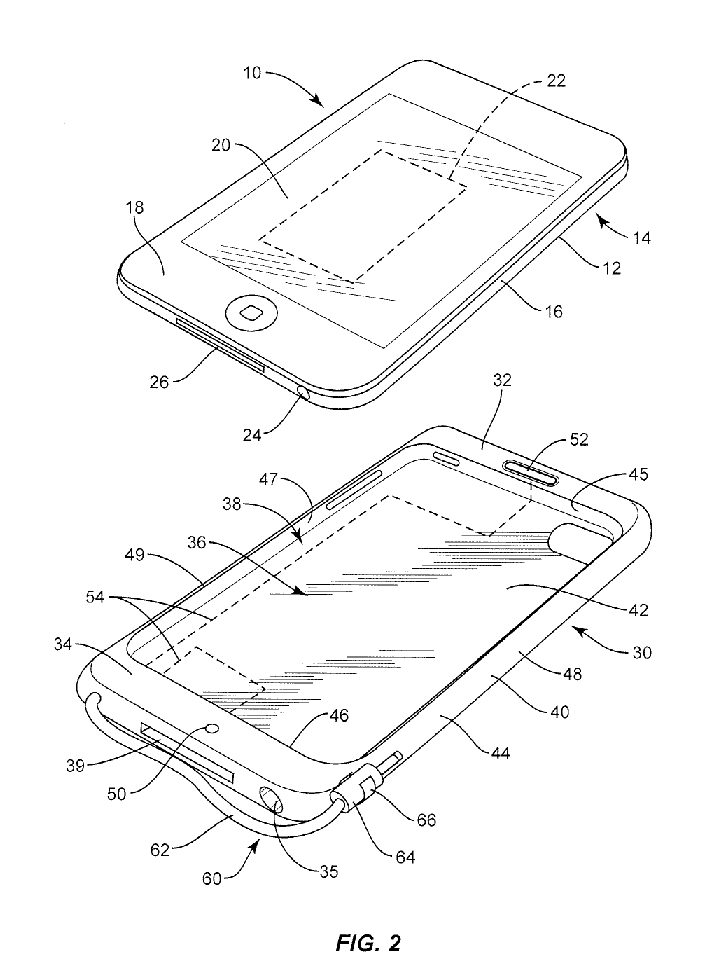

FIG. 3 shows the combinational device of FIG. 1 in the plugged configuration.

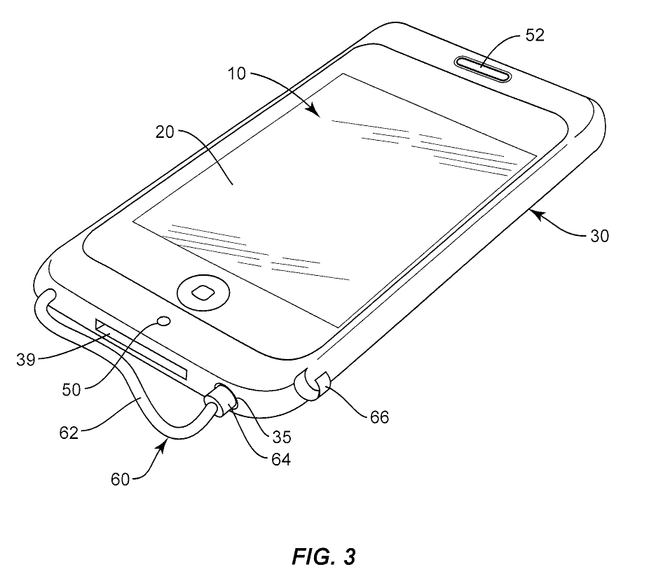

### DETAILED DESCRIPTION

In one embodiment, the present invention provides a protective case for a portable wireless communications device. For illustrative purposes, a wireless communications device 10 like the IPOD TOUCH brand product from Apple, Inc. will be used in the description below, but it should be understood that the invention is applicable to other wireless communications devices as well.

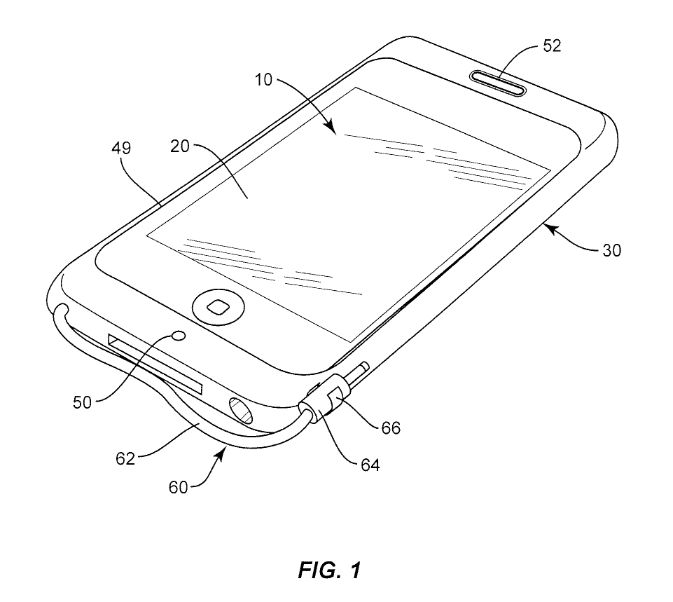

The portable wireless communications device 10 shown in FIG. 1 comprises a housing 12 enclosing electronics 22 therein. The housing 12 has a rear wall 14, a perimeter wall 16, and a front face 18 having a display 20 thereon. The electronics 22 include suitable circuitry for storing and playing audio and advantageously video. The electronics 22 also include suitable circuitry for bi-directional wireless communications over a network other than a cellular telephone network, such as a Wi-Fi network connected to the internet. The display 20 is controlled by the electronics 22, and typically also functions as user control interface. The front face 18 may also contain user input controls of the kind known in the art. The wireless communications device 10 further comprises a headphone jack 24 for outputting audio signals to an attached earphone. The jack 24 is advantageously multi-functional in that it is also configured to receive audio input. The jack 24 may be located on the lower edge of the perimeter wall 16, although other locations are also possible. A separate dock connector 26 is also typically located on the lower edge of the perimeter wall 16. Additional details of the wireless communications device's construction and operation are not detailed further herein because they are known in the art and not important for understanding the present invention.

The protective case 30 shown in FIG. 1 is removably mounted to the housing 12 of the wireless communications device 10. The protective case 30 includes a shell 40, a microphone 50, a speaker 52, and a connection cable 60. The shell 40 includes a substantially planar rear or back wall 42, and a plurality of sidewalls 44 extending generally forwardly from the back wall 42 generally perpendicular thereto. The sidewalls 44 include a top wall 45, a bottom wall 46, a left wall 47, and a right wall 48. The sidewalls 44 and the back wall 42 together help define a cavity 36 in the shell 40. The cavity 36 is sized and configured to receive the wireless communications device 10 therein. The upper portions of the sidewalls 44 advantageously curls inward some to form a front rim 49 that frames a display opening 38. The upper portion 32 of the shell 40 has a speaker 52 embedded therein. Preferably, the portion of the rim 49 associated with the top wall 45 is rather elongated in relation to the rim portions associated with the left wall 47 and right wall 48. The speaker 52 is advantageously embedded in this upper rim portion, and is oriented frontward. Likewise, the lower portion of the shell 40 has a microphone 50 embedded therein. Preferably, the portion of the rim 49 associated with the bottom wall 46 is rather elongated in relation to the rim portions associated with the left wall 47 and right wall 48. The microphone 50 is advantageously embedded in this lower rim portion, and is oriented frontward. The shell 40 is advantageously made from a compliant elastic material, such as silicone, rubber, or the like. Other non-rigid materials are also possible, such as leather and the like. When joined to the device 10, the back wall 42 and sidewalls 44 overlie the corresponding rear wall 14 and perimeter wall 16 of the device 10, advantageously entirely covering the same other than for any openings required to provide access to connectors and/or buttons/switches on the device 10.

The connection cable 60 includes a short cord 62 extending away from the shell 40 that terminates in a plug 64 suitable for plugging into the headphone jack 24 on the wireless communications device 10. While the illustrative cord 62 is shown as straight, the cord 62 may alternatively be a coiled (spiral) cord, or a mixture of straight and coiled, if desired. The plug 64 is operatively connected (i.e., electrically connected) to the speaker 52 and microphone 50 by cord 62. For example, wires 54 or other conductors may be embedded in the shell 40 and run from the cord 62 to the speaker 52 and microphone 50. Less advantageously, the connecting wires 54 may alternatively run in mostly open channels in the shell 40 to the speaker 52 and microphone 50, or be routed loosely through the cavity 36.

In order to allow the plug 64 to be inserted in the headphone jack 24, the lower portion of the shell 40 also has an opening 35 corresponding to the headphone jack 24, such that the opening 35 is aligned with the jack 24 when the wireless communications device 10 is inserted in the cavity 36. This opening 35 is typically located in the bottom wall 46. The bottom wall 46 may advantageously further include a suitable opening 39 to allow the docking connector 26 of the wireless communications device 10 to be accessed while the case 30 is installed. If desired, the lower portion 34 of the shell 40 may further include a clip 66 affixed to the exterior of the shell 40. The clip 66 is sized and configured to releasably receive the cord 62 and/or plug 64, particularly when the plug 64 is not in use. While the illustrative clip 66 is disposed on the right sidewall 48 near the bottom wall 46, other positions may alternatively be employed, such as on the bottom wall 46, near the opening 39 for docking connector 26.

Assuming the case 30 is a single piece, the case 30 may be releasably mounted on the wireless communications device 10 by sliding the wireless communications device 10 into the display opening 38 and slightly temporarily distorting the shell 40 so that it snaps over the perimeter wall 16 of the wireless communications device 10 with the back wall 42 adjacent the rear wall 14. With the case 30 mounted to the wireless communications device 10, the sidewalls 44 overlie the perimeter wall 16 of the device 10, and the rim 49 slightly overlies the front 18, with the display 20 uncovered by the shell 40 and accessible through the display opening 38. The headphone jack 24 is accessible through the corresponding opening 35 in the shell 40.

With the plug 64 not plugged into the jack 24, the combination of the case 30 and the wireless communications device 10 can be used as a conventional wireless communications device 10, with the audio output through the usual paths, such as a separate headphone or built-in speaker in the wireless communications device 10. The cord 62 and/or plug 64 of the connection cable 60 is advantageously gripped by the clip 66 so as to be in a safe storage position. The case 30, in this configuration, acts as a protective case, with the compliant material of the shell 40 helping to absorb mechanical shocks in a conventional fashion.

With the plug 64 plugged into the jack 24, the speaker 52 and microphone 50 are operatively connected to the electronics 22 in the wireless communications device 10. When an appropriate “phone” application is launched on the wireless communications device 10, such as SKYPE, the application may access the inputs from the microphone 50 and output via the speaker 52. Due to the positioning of the microphone 50 and speaker 52, above and below the display 20, there is enough spacing between the two that the wireless communications device 10 may be held to the user's head and used like a conventional telephone handset. As discussed above, the uplink from the wireless communications device 10 to the remote party (at the other end of the “call’) is via Wi-Fi or similar network that is not the cellular telephone/data network. Accordingly, the user can use the combined device 10 as something similar to a portable cellular telephone without having a cellular telephone subscription. The clip 66, in some embodiments, may grip the connection cable 60 in a different location than described above, or the connection cable 60 may bypass the clip 66. In this configuration, the case 30 acts as both a protective case and as audio input/output accessory that allows for the privacy of the call to be maintained.

In both the plugged (or plugged-in) and unplugged configurations, the display 20 remains readily accessible through the display opening 38.

The discussion above was generally in the context of a soft and pliable case 30 with a one-piece construction. That is, the shell 40 of the case 30 would be formed as a single part, without removable portions. For example, the case 30 could be molded from silicone, with the speaker 52, microphone 50, wires 54, and connection cable 60 affixed to the shell 40 during the molding process. While such arrangement is believed advantageous, it is not required in all embodiments. In some embodiments, the shell 40 may be made from a hard material, such as metal, ABS or polycarbonate plastics, or the like, and/or may be made in two or more joinable parts with suitable electronic connections as necessary to connect the speaker 52 and microphone 50 to the connection cable 60. If made in multiple parts, the shell 40 may be assembled around the wireless communications device 10 by, for example, sliding the various portions over the corresponding portions of the device's housing 12 and snapping the portions together.

In some embodiments, the case 30 may further include a suitable removable cap (not shown) for selectively covering the opening for jack 24. Such a cap, if present, should be tethered to the shell 40, such as by a living hinge arrangement.

The back wall 42 of the shell 40 may not fully cover the rear wall 14 of the device 10 in some embodiments. For example, the back wall 42 may include one or more suitable openings for corresponding camera lenses, control buttons, or the like on the device 10. Further, the back wall 42 may be foraminous or the back wall 42 may only extend inward only partially from the sidewalls 44. Further, the back wall 42 may be made from a different and harder material than the sidewalls 44, such as being made of polycarbonate while the sidewalls 44 are made from silicone, if desired. And, the shell 40 may be in any desired color or combination of colors and may have any suitable graphics or other indicia embedded or printed thereon, as is desired.

The present invention may, of course, be carried out in other specific ways than those herein set forth without departing from the scope of the invention. The present embodiments are, therefore, to be considered in all respects as illustrative and not restrictive, and all changes coming within the meaning and equivalency range of the appended claims are intended to be embraced therein.

What is claimed is:

1. A protective case for a wireless communications device having a display on a front thereof and an earphone jack, the protective case comprising:
a shell comprising:
a back;
sidewalls extending generally perpendicular to the back;
a cavity defined by the back and sidewalls; the cavity sized and configured to receive the wireless communications device therein;
a rim extending from the sidewalls generally opposite the back; the rim defining a display opening sized and configured to expose the wireless communications device display when the wireless communications device is disposed in the cavity;
a speaker embedded in the shell;
a microphone embedded in the shell;
the speaker and microphone disposed on opposing sides of the display opening;
a connection cable affixed to the shell toward one end of the cable and comprising a cord and an electrical plug; the cord operatively connecting the plug to both the microphone and the speaker.

2. The protective case of claim 1 wherein the shell is flexible.

3. The protective case of claim 1 wherein the connection cable is affixed to the shell proximate the microphone.

4. The protective case of claim 1:
wherein the sidewalls comprise an upper wall and a lower wall;
wherein the speaker is disposed proximate the upper wall;
wherein the microphone is disposed proximate the lower wall;
wherein the lower wall comprises a docking connector opening extending into the cavity.

5. The protective case of claim 1 further comprising a clip affixed to an exterior of the shell and adapted to secure at least one of the plug and the cord.

6. The protective case of claim 1 wherein the sidewalls comprise an opening sized and configured to leave the headphone jack exposed when the wireless communications device is disposed in the cavity.

7. The protective case of claim 1 wherein the back extends is continuously between all the sidewalls.

8. The protective case of claim 1 wherein the sidewalls are made from silicone.

9. The protective case of claim 8 wherein the shell is made from silicone.

10. The protective case of claim 1 wherein the plug is operatively connected to both the microphone and the speaker via wires embedded in the shell.
